(19) United States
(12) Patent Application Publication
(10) Pub. No.: US 2016/0180629 A1
(43) Pub. Date: Jun. 23, 2016

(54) Method for Maintenance of a Retail Unit

(71) Applicant: Elstat Limited, Preston (GB)

(72) Inventors: Colin Chapman, St Ives (GB); Philip Eric Lambert, Preston (GB); Neil Pendlebury, Blackpool (GB); Johannes Paulus Hendrikus Eekhout, Vijfhuizen (NL); Nearchos Nearchou, London (GB); Anthony Francis Barcroft, Chester (GB); Kevin Milton Patterson, Blackburn (GB)

(21) Appl. No.: 14/974,496

(22) Filed: Dec. 18, 2015

Related U.S. Application Data
(60) Provisional application No. 62/094,598, filed on Dec. 19, 2014.

(30) Foreign Application Priority Data
Dec. 19, 2014 (GB) 1422813.4

(51) Int. Cl. G07F 11/00; H04W 4/00; G05B 15/02

(52) U.S. Cl. CPC G07F 11/002; G05B 15/02; H04W 4/008

(57) ABSTRACT

Described is a method for maintaining a retail display or vending unit. The method includes obtaining and storing data from sensors located in or on the unit in a control system including data communication means, wherein the data is sent to and accessed by remote telecommunication means via the data communication means, and wherein operation of the unit is changed based on the data.

### CROSS-REFERENCE TO RELATED APPLICATIONS

This application is related to and claims priority from (i) U.S. Provisional Patent Application No. 62/094,598, titled “Method for Maintenance of a Retail Unit,” filed Dec. 19, 2014; and (ii) U.K. Patent Application GB 1422813.4, filed Dec. 19, 2014, the entire contents of both of which are hereby fully incorporated herein by reference for all purposes.

The present invention relates to the gathering of information and data by a retail display unit and the processing of such information and data to enable efficient function of the unit.

A retail display cabinet or unit generally comprises one or more storage compartments in which items, preferably packaged items, boxed items or items in cartons, may be stored and displayed for sale to customers. Such cabinets or units display and store almost any type of product, generally presented to the consumer in a box, carton, wrapping, bag and the like, such as cigarettes, packaged foods, drinks, over the counter medicine, sweets, perfume, novelties, and the like.

Typically, such a unit is used for storing and dispensing items as part of a point of sale display rack directly accessible by the customer through self-selection or a sales clerk or other store employee. Alternatively, such a cabinet or unit provides a self-selection and pay option, typically referred to as a vending machine or unit.

A challenge for both retailers and providers of stock is the efficient management of retail display and vending units. For example, an empty shelf results in loss of sales because there is no product for a consumer to purchase. A display unit that is illuminated for 24 hours is not energy efficient because full illumination does not need to be provided when there are no potential customers. Refrigerated display units present additional issues such keeping a unit cool at times of day when there are no potential customers resulting in energy inefficiency. In addition, refrigerated units include the technical considerations of a refrigeration unit that need to be kept in good working order and that may develop faults—a refrigeration unit that is unable to cool means the unit is out of commission and no stock can be sold.

A retailer needs to monitor stock levels to ensure a unit is fully and properly stocked, a stock provider needs to ensure that the retailer has sufficient stock so the unit is able to be fully stocked, and a refrigerated unit needs to be monitored and serviced to enable its continuous and efficient operation. Such detailed and time consuming attention often falls by the way-side, typically because a retailer is busy with other matters to keep a suitably close eye on stock levels. Stock in storage is typically managed on the basis of average sales and so is not able to cope with fluctuations in product demand.

In addition, a service engineer needs to make regular visits to ensure the continuous functioning of a refrigerated unit and, if the unit does not include a diagnostic function, expensive parts may be replaced unnecessarily and/or parts may need to be order, leaving the unit out of order. Thus, the efficient management and running of a retail display unit, particularly a refrigerated unit, is a constant and costly process if use of a unit is to be maximised.

It is also important for customers to be able to locate a unit and to gain access to the latest promotions, product information, and any other appropriate marketing literature or images. Point of sale marketing is traditionally achieved by the retailer displaying information on or next to a unit so that customers are able to see the latest offers. However, this material is not always up to date and it is often difficult for the retailer to change. Also, this means of communication significantly limits the amount of information that can be communicated at the point of sale.

An operator/retailer also has an interest in minimising maintenance costs and the time and effort required to maintain refrigerated units in good working order. In some instances, it can be difficult for maintenance staff to locate a refrigerated unit to be serviced, particularly when there are a large number of units on a site, or if the site itself is large.

In the current era of energy conservation, minimising operating costs of units, particularly refrigerated units is desirable. A significant operating cost is the energy used to keep refrigerated products at a desired temperature. Minimising energy usage reduces costs and has a positive impact on the environment.

It is against this background that the Applicant has appreciated that there is a need for a retail display unit with an integrated management system to maximise the commercial potential of such a unit and ensure its cost and energy efficiency.

To this end, the present invention resides in a method for maintaining a retail display or vending unit, the method comprising obtaining and storing data from sensors located in or on the unit in a control system including data communication means, wherein the data is sent to and accessed by remote telecommunication means via the data communication means, and wherein operation of the unit is changed based on the data.

In this way, the unit is provided with an interactive “intelligence” that is informed and controlled based on data collected by the unit about its status at a point in time. In particular, the present invention enables the unit to be managed remotely and overcomes the need for the unit to be monitored and serviced regularly by in-person inspection. Not only does the method of the invention allow faults to be monitored but for stock and sales to be monitored to enable the output of the unit to be maximised with minimal on-site input and/or presence.

It will be appreciated that data may be obtained from one or more type of sensor and the data stored in the control system. Typical and suitable sensors may include temperature, illumination, door opening/closing, stock level, locked/unlocked status and presence of a person.

In an optional embodiment, data may be obtained from at least one door sensor to monitor opening and/or closing action of a door on the unit. The sensor may either provide data on use of the unit or access to compartments housing machinery such as motors and refrigerator systems.

A further option is to obtain data from a person/motion detection device to detect and/or monitor the presence of a person within the vicinity of a unit, and the control system is arranged to send person/motion detection data to at least one of the remote data centre and the portable telecommunications device. Suitable person and/or motion detector devices include passive infrared (PIR) devices and vibration sensors. These devices allow a relatively accurate measurement of footfall within the vicinity of a unit. When door sensor data and/or the footfall data is compared with stock level data, it is possible to derive a sales conversion factor which is of interest to an operator/retailer.

A yet further option is to obtain data from a plurality of stock sensors, wherein each stock sensor is arranged to measure a quantity of stock within a respective portion of the unit. For example, a unit typically includes at least first and second shelves (or first and second zones) so the unit may include a first stock sensor for measuring the quantity of stock on the first shelf (within the first zone) and a second stock sensor for measuring the quantity of stock on the second shelf (within the second zone). In a preferred embodiment, the or each stock sensor includes a photosensor the measures light levels within unit.

Alternatively or in addition, data may be obtained on the quantity or type of stock loaded into the unit to assist with analysis of sales trends and product placement.

To assist with data analysis, it is advantageous if the time is recorded, ideally real time. In this way, events such as movement of stock, use of the unit and faults may be tracked over the course of a day, week, month or other period. For example, time data may be recorded to enable a retailer or product supplier to evaluate when the unit was emptied, or was running low on stock and/or when stock in the unit was replenished. Alternatively, or in addition, the method may comprise recording data by shelf in the unit to provide information on specific product sales and purchasing trends.

In one embodiment, a microprocessor in the control system may be programmed to change settings within the control system and/or unit. As an example, the microprocessor may be programmed to change one or more settings in the control system and/or unit based on real time. For example, operation of the unit may be based on business hours so that the unit is changed to a hibernation or sleep mode to conserve energy. Another example is temperature of the unit may be altered according to the time of day. This may be particularly pertinent in regions where there is a significant difference between midday and midnight temperatures.

Ideally, a change to the one or more settings is based on data received from the one or more sensors. Such a change may be made automatically via the programmed microprocessor in the control system. Alternatively, the change may be made by or in response to a request received from the remote telecommunication means. In this way, the functioning of the unit may be altered and managed remotely based on data collected and sent the unit. For example, if there is an unexpected surge in sales of stock, a special request or alert may be instigated to ensure the unit is sufficiently stocked to cope with demand.

The method may further comprise changing an operational state of a component or module in the unit (e.g. switching on/off), selecting an operational mode for the unit where more than one mode is available (e.g. switching to and from an energy saving mode), changing a parameter value (e.g. set a temperature value, time value, sensor device sensitivity), selecting a default setting, testing a refrigerator function, and/or updating firmware and/or software in response to the data. Again, such a change may be based on data received from the one or more sensors, made automatically via the programmed microprocessor in the control system, or made by or in response to a request received from the remote telecommunication means.

In one example, the unit may be changed from a first mode to a second mode, and/or from a second mode to a first mode, at least in part, according to signals received from a clock or real-time clock or data received from at least one sensor. This enables the unit to react to regular changes in its surroundings and sales.

As an example, retail display or vending units may be refrigerated to store perishable foodstuffs such as drinks and foods. A first mode for such a unit may be a retailing mode in which the unit is cooled to an optimal temperature for the products to be stored, optionally for immediate consumption. For example, a canned drink is ideally sold at a temperature of around 4° C. So, an acceptable operating temperature range of such a unit is between about 3° C. and about 5° C.

A second mode for a refrigerated unit may be an energy conservation mode, which may be used, for example, at night time when the retail store is closed and/or when it is determined that there have been no customers in the vicinity of the refrigeration unit for a selected period of time. To conserve energy, the unit may be set to operate at a temperature selected to be sufficiently high to reduce energy usage, but low enough to maintain the quality of the foodstuffs for the period in which the cooling system operates in the conservation mode.

For example, the second temperature range can be around 10° C., with an acceptable operating range of between about 9° C. and 11° C.

Optionally, the change from a first mode to a second mode and/or from a second mode to a first mode may be, at least in part, according to signals received from at least one sensor device. For example, the control system may be switched from a first mode to a second mode based on signals received from a door sensor and/or a person/motion sensor.

Advantageously the control system may obtain and send additional data to the remote telecommunications means. For example, the control system may send data relating to any sensor, operational state of a component or module, the operating mode of a component or module where more than one operational mode is selectable, parameter values; firmware and/or software versions, and/or fault codes. For example, the control system provide data on at least one of the following: a first temperature; an acceptable range of values associated with the first temperature; a second temperature; a range of acceptable values associated with the second temperature; a current cooling system operating mode; trigger values for switching between operating modes; the time of commencing an operating mode and the time of finishing the operating mode; power consumed by the unit (for example can be determined by measuring the current draw to the unit over time). Data may be sent in response to a request by the remote data centre or in accordance with the control systems own programming.

Alternatively or in addition, the method further comprises transmitting an identification code that is unique to the unit. The unique identification code may be of any suitable type, such as a unique code stored in the control system or associated with an electronic component or device, such as a microprocessor or a communications device such as a modem integrated into the unit.

Optionally, the identification code may be linked to location and/or mapping software. This enables data to be linked to the correct unit. It also provides the option of providing either a user or service/maintenance personnel with information on the exact location of the unit. The location and/or mapping software may be programmed to use the position system of the telecommunication means to determine the geographical location of the telecommunication means and provide information and/or directions to retail units located in the vicinity of the telecommunication means. Advantageously, the mapping software provides routing information, to enable a customer or service/maintenance personal to get from a current location to a local or specific unit.

In one embodiment, the data may be sent to and accessed by either an Ethernet connection or mobile wireless internet or broadband access. Suitable mobile wireless internet or broadband access may be provided by one or more of: Wi-Fi, Bluetooth®, General Packet Radio Service (GPRS), and Global System for Mobile Communications (GSM).

In one embodiment, the data may be sent to the remote telecommunication means on demand or request by the remote telecommunication means. Alternatively, the data may be sent on a timed basis.

In a further embodiment, the method comprises requesting fault codes from the control system by the remote telecommunication means. This enables the remote telecommunication means to act as a diagnostic tool and check that the unit is operating correctly.

Alternatively or in addition, the remote telecommunications means may request data from the control system relating to stock held in the unit and the control system may be programmed to send that data to the remote telecommunications means. The stock data may be related to a customer offer, such as pricing information, discounts, container size, combination purchase, attractive pictures of the product(s), ingredients, energy contents, allergy information, time limited offers, etc. It is advantageous if the stock data is stored in the control system and may be loaded into the control system from a remote data centre, the data having been provided by the supplier of the stock and/or the retailer.

Alternatively or in addition, the method further comprises clearing fault codes in response to instructions received from the remote telecommunication means. This enables service/maintenance personnel to monitor a unit and clear non-critical fault codes without having to make a site visit.

In a yet further embodiment, the method further includes inputting parameter values into the control system via a user interface. The user interface may be on the unit or the remote telecommunication means, thereby enabling service and maintenance personal, as well as retail staff, to change parameters either directly on the machine or remotely to enable optimal operation of the unit.

It will be appreciated that the remote telecommunication means may be a computer or a mobile telephony device such as a mobile telephone or a tablet. Optionally, the telecommunications means may be programmed with an application that interacts with the control system. The application may be an operator/retailer application and programmed to obtain many different types of control system data and to change settings in the control system. The application may be a consumer application that has access to consumer appropriate information only, such as product and commercial information such as promotions. In some circumstances, a mobile telephony device may be programmed with either the operator/retailer application or the consumer application, although some devices may be programmed with both applications.

Ideally, the remote telecommunication means is a data centre that is programmed to store data received from the control unit via the data communication means and optionally analyse the data received. This allows suppliers of stock to monitor the performance of a unit without having to be on-site, which would interfere with day-to-day operation of the unit and potentially obstruct sales. This is particularly advantageous where a supplier or owner of a unit has multiple units in many and varied locations. This feature also enables: asset tracking; sales comparison; consumer engagement; retail engagement; stock tracking, including levels and stock type; maintenance, including predictive maintenance; preventative maintenance, and diagnostics.

### BRIEF DESCRIPTION OF THE SEVERAL VIEWS OF THE DRAWING

The present invention will now be described in more detail by way of non-limiting examples with reference to the accompanying drawings in which:

FIG. 1a is a cut away schematic illustration of a typical refrigerated beverage merchandising unit (refrigerator unit);

FIG. 1b is a diagrammatic view of a refrigerator control system for the refrigerator unit of FIG. 1a;

FIGS. 2a to 2c illustrate a stock sensing method with FIG. 2A representing a view from above a refrigerator unit showing a shelf fully stocked. FIG. 2B shows the shelf partially emptied and FIG. 2C shows the shelf completely empty;

FIG. 3 is a graph plotting the change in light level with depletion of stock from a cabinet;

FIG. 4 is a flow diagram illustrating the flow of instructions for the stock sensing method for an embodiment of the present invention;

FIG. 5 is a flow diagram illustrating the light reading circuit;

FIG. 6 is a diagrammatic view of a network of refrigerator units in accordance with the invention, illustrating data transfer between the refrigerator units to a remote data centre, data transfer between the refrigerator units and a mobile telephone device, analysis of data at the remote data centre, and the provision of analysed data to operators/retailers via a computer interface; and

FIGS. 7a and 7b are graphs illustrative of some of the data that can be provided to operators via the computer interface.

### DETAILED DESCRIPTION

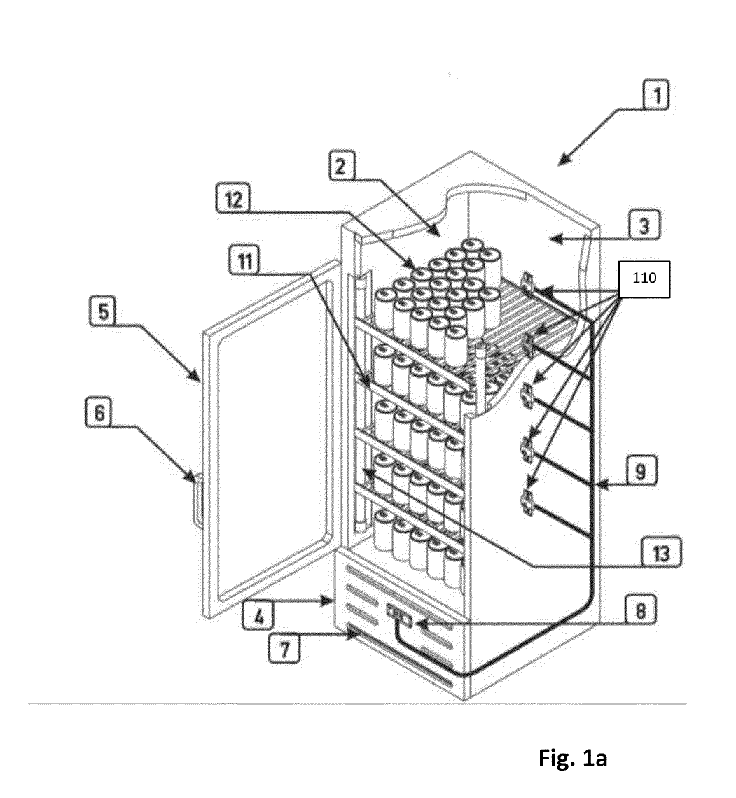

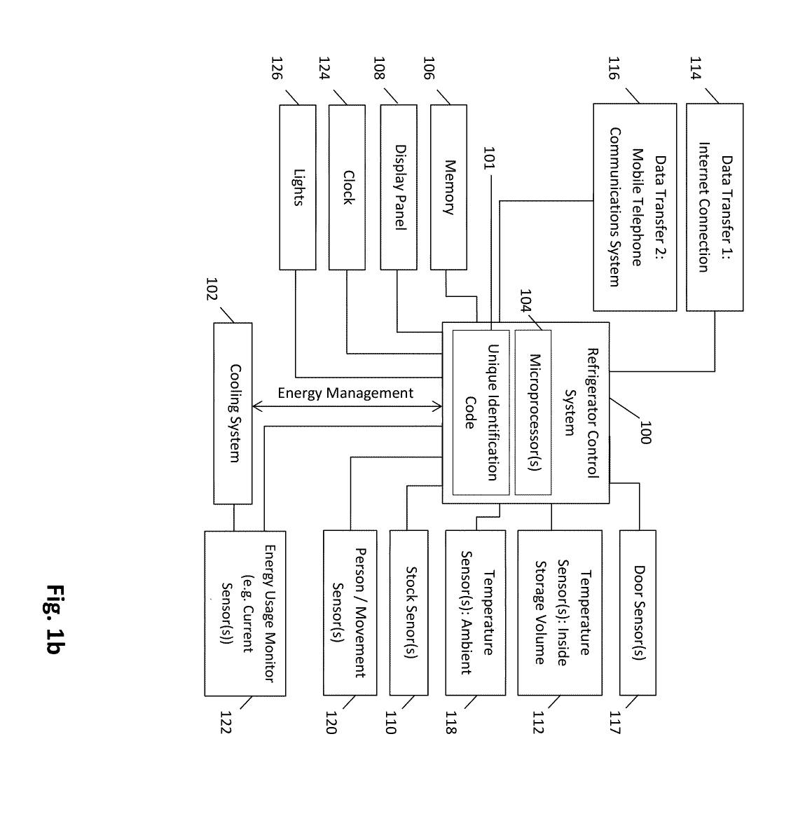

FIG. 1a shows a retail refrigeration unit 1, which is used to keep foodstuffs cool in a retail environment. In FIG. 1a the retail refrigeration unit is in the form of a refrigerated beverage merchandising unit (RBMU) 1. The refrigerator unit 1 has two parallel side walls 2 separated orthogonally by a rear wall 3 and a front panel 4 to form a cuboid structure. For ease, the top and bottom of the cuboid structure are not shown in the illustration.

The front panel is made up of a hinged door 5, which includes a handle 6. The door 5 enables a customer to access a storage volume in order to remove one or more product units from the storage volume, in order to purchase the product(s) at a shop till. The door 5 also provides an operator with access to the storage volume in order to replenish stock.

An air vent 7 is located below the hinged door 5. The air vent 7 allows air to circulate around a cooling system 102.

FIG. 1b shows diagrammatically a refrigerator unit control system 100. The control system 100 includes: at least one microprocessor(s) 104; at least one stock sensor 110; at least one internal temperature sensor 112; a first data communications module 114 arranged to transfer data from the refrigerator unit 1 to a remote data centre 200, and to receive incoming data from the remote data centre 200; and a second data communications module 116 arranged to transfer data from the refrigerator unit 1 to a mobile telephone device 300, and to receive incoming data from the mobile telephone device 300. The control system 100 may also include at least one of the following: memory 106; display panel 108; at least one door sensor 117; at least one ambient temperature sensor 118; at least one person/movement sensor 120; at least one energy usage monitoring device 122; clock 124 and lights 126.

The refrigerator unit 1 has a unique identification code 101 to uniquely identify the refrigerator unit 1 to the remote data centre 200 and/or the mobile telephone 300. The unique identification code 101 can be of any suitable type, for example it can be a unique code stored in the memory 106, or it can be a unique code associated with an electronic component or device, such as the microprocessor(s) 104, or a communications device 114,116 such as a modem.

The at least one stock sensor 110 is connected to the microprocessor(s) 104 and is arranged to monitor stock levels within the storage volume. The microprocessor(s) 104 determines the quantity of stock within the storage volume from signals received. A preferred stock sensing arrangement and method is set out below.

The internal temperature sensor(s) 112 monitors the temperature within the storage volume. The temperature sensor(s) 112 is connected to the microprocessor(s) 104. The microprocessor(s) 104 determines the temperature within the storage volume from signals received, and therefore provides an indication of the product temperature.

The door sensor 117 monitors opening/closing of the door 5. The door sensor 117 is connected to the microprocessor(s) 104. The microprocessor(s) 104 determines from signals received, for each instance of door opening. The door sensor 117 can be, for example a magnetic senor.

The ambient temperature sensor(s) 118 monitors the ambient temperature outside of the refrigerator unit 1. The temperature sensor(s) 118 is connected to the microprocessor(s) 104. The microprocessor(s) 104 determines the ambient temperature from the signals received.

The person/movement sensor 120 monitors movement at the front of the refrigerator unit 1. The person/movement sensor 120 is connected to the microprocessor(s) 104. The microprocessor(s) 104 determines from signals received each instance of a person passing the refrigerator unit 1. Preferably the person/movement sensor 120 comprises a Passive Infrared Detector (PID). This provides a measure of the footfall at the refrigerator unit 1.

The energy usage monitoring device 122 monitors the amount of energy used by the cooling system 102. One way to do this is to monitor the amount of electrical energy used by the cooling system, for example by using an ammeter to measure the current drawn by the compressor.

The clock 124 is preferably a real-time clock and preferably includes a time and date format.

The memory 106 is used to store any data required for the proper functioning of the refrigerator unit 1, including sensor readings, product data, time data, etc. It can be of any suitable type, and may include volatile memory such as RAM and non-volatile memory such as Flash memory.

When obtaining data from at least one of the sensors, and preferably each of the sensors, the control system 100 also records time and data for analytical purposes. The specific sensors and interactions recorded will be selected by the operator/retailer according to his particular interests. In preferred embodiments the control system 100 records the time of footfall detection, door opening and/or door closing, interactions with mobile telephones 300, detection of stock changes, energy usage, and time associated with operating modes.

The first data communications module 114 is typically arranged to transfer data via the internet between the refrigerator unit 1 and the remote data centre 200. The first data communications module 114 can comprise any suitable means, for example any suitable wired system, any suitable wireless system, or any combination thereof. Typically, the first data communications module 114 includes at least one of: an Ethernet connection; GSM modem; and Wi-Fi hub. The first data communications module 114 is arranged to send data of any type that is available to it, for example: door opening/closing data; temperature data; stock level data; person/movement detection data; energy usage data; the number of interactions between the second data communications module 16 and a consumer mobile telephone 300; the number of interactions between the second data communications module 16 and an operator/retailer mobile telephone 3000; time data, including the time and date on which a mobile telephone (consumer or operator) interacted with the control system 100; unique identification code; cooling system data; operational settings; including desired operational temperatures, operating times, etc.; any data stored in memory 106; error codes; and maintenance related data.

The first data communications module 114 is arranged to receive data from the remote data centre 200. For example; the remote data centre 200 may update firmware and/or software; change operational settings, including changing parameter values, changing a component's or module's operating status, changing a component's or module's operating mode; store data in the memory 106; cancel error codes; provide reset instructions; energy mode instructions; provide maintenance data; provide data of interest to a consumer, such as data relating to product promotions; product information, such as ingredients and allergy information; pricing information; and vouchers.

The second data communications module 116 is arranged to transfer data wirelessly to the mobile telephone device 300, typically by way of a localised wireless communication system. The second data communications module 116 typically includes at least one of: a GPRS module; GSM module; Bluetooth® module and a Wi-Fi hub. The second data communications module 116 is arranged to communicate with any suitably programmed mobile telephone device 300.

The mobile telephone device 300 can be programmed with a first (operator/retailer) application, which may be used by an employee of the refrigerator unit operator/retailer, or a contracted service provider. The operator/retailer application is arranged to communicate with the control system 100 via the second data communications module 116. The operator/retailer application is arranged to obtain any type of data available, according to user selections, or automated downloads, for example: door opening/closing data; temperature data; stock level data; person/movement detection data; energy usage data; time data; unique identification code; cooling system data; operational settings, including desired operational temperatures, operating times, etc.; any data stored in memory 106; error codes; and maintenance related data. The operator/retailer application is also arranged, according to user selections, or automated process, to update firmware and/or software; change operational settings, including changing parameter values, changing a component's or module's operating status, changing a component's or module's operating mode; store data in the memory 106; cancel error codes; provide reset instructions; energy mode instructions; provide maintenance data; provide data of interest to a consumer, such as data relating to product type, product promotions, product information such as ingredients and allergy information, pricing information, and vouchers.

Accordingly, the operator/retailer application provides the user with the ability to interact with the refrigerator unit and to control operation of at least one function of the refrigerator unit 1. Typically, the operator/retailer mobile telephone 300₀ communicates with the second data communications module 116 using a localised wireless communication means such as Bluetooth® or Wi-Fi, and therefore the operator/retailer representative is typically on site. For example, data may be exchanged during a maintenance operation, or a routine data collection visit. When in range, the user of the operator/retailer mobile telephone 300ₒ contacts second data communications module 116 via the operator/retailer application. This may include a security protocol, such as entering a password, or an automatic exchange of authorisation codes.

The mobile telephone device 300 can also send data to the remote data centre 200.

Additionally, or alternatively, the mobile telephone device 300 can be programmed with a second (consumer) application, which may be used by a consumer (purchaser) of the product. The consumer application is arranged to communicate with the control system 100 via the second data communications module 116. Typically, the consumer mobile telephone 300_{c} communicates with the second data communications module 116 using a localised wireless communication means such as Bluetooth® or Wi-Fi, and therefore the consumer is typically on site at the time of the communication. When in range, the user of the consumer mobile telephone 300_{c} contacts second data communications module 116 via the consumer application. This may include a security protocol, such as entering a password, or an automatic exchange of authorisation codes. The consumer is able to obtain data stored in the memory 106 which may be of interest to the consumer, such as data relating to product type, product promotions, product information such as ingredients and allergy information, pricing information, and vouchers, etc. The consumer application is not arranged to obtain any of the system data (sensor output, parameter settings, etc.) or to control any settings of the control system 100.

The remote data centre 200 stores location information for each of the refrigerator units 1 in a database. This information is provided to mapping software on the mobile telephone device 300, which is preferably included as a function within the operator/retailer and/or consumer applications, or the operator/retailer and/or consumer applications are arranged to interact with a separate mapping application. The application includes a search function to find refrigerator units 1 in the vicinity of the mobile telephone device 300. By determining the operator's/consumer's current position from the mobile telephone's positioning system (typically GPS), and obtaining the refrigerator unit 1 location information the software is able to identify, and display, refrigerator units 1 located locally. The mapping software can provide directions to the operator/consumer to guide him/her from his/her current position to one of the refrigerator units 1. For example, this may be the refrigerator unit 1 selected by the user from those displayed. Alternatively, the software may be programmed to select the refrigerator unit 1, which is geographically closest to the user; the refrigerator unit, which has the shortest journey time, in some cases by mode of transport (car/cycling/walking/public transport); or the nearest refrigerator unit 1 which has a particular product type, where the product type stocks are also displayed in the software.

The locations of the refrigerator units 1 can be shown graphically on a visual display of the map to aid selection, together with the user's current position.

Energy Management

The cooling system 102 includes a condenser, expansion valve, evaporator and compressor (not shown). The control system 100 controls operation of the cooling system 102 to maintain product stocks at desired temperatures. The control system 100 is arranged to control the cooling system 102 to operate in at least first and second modes.

The first mode is a retailing mode. In the first mode, the temperature within the storage volume is maintained within an acceptable range of a first temperature. The first temperature is a retailing temperature, that is, the temperature at which the products in the refrigerator unit 1 are sold. This is typically selected by the operator/retailer, and may be adjusted to suit the product type. For example, a canned beverage is typically sold at a temperature of around 4° C. The acceptable operating range in the first mode for this product is typically around 3° C. to 5° C.

The second mode is an energy saving mode. The energy saving mode can be used, for example at night time when a retail store is closed and/or when there are no customers are in the vicinity of the refrigeration unit for a long period of time. In the second mode, the temperature within the storage volume is maintained within an acceptable range of a second temperature. The second temperature is different from the first temperature. The second temperature is typically higher than the first temperature and therefore less energy is consumed by the refrigeration unit in the energy saving mode. The second temperature is selected to be sufficiently high to reduce energy usage, but low enough to maintain the quality of the foodstuffs for the period in which the cooling system operates in the conservation mode. The second temperature is also selected such that cooling system 102 is capable of cooling the storage volume to the first temperature, when the retail mode is selected, within an acceptable period of time. For example, the second temperature can be around 10° C., and an acceptable operating range is within 9° C. to 11° C.

The control system 100 is programmed to switch between the first and second modes. Preferably, a first time value associated with the first mode, and a second time value associated with the second mode, is stored in the memory 106. The control system 100 switches between the first and second modes by comparing an input signal received from the clock 124, with the time values stored in the memory 106. The time values can be set, for example according to shop opening hours. The time values can be set locally using a refrigerator unit user interface, by the mobile telephone device 300, via the remote data centre 200, or any other authorised operator/retailer data link with the refrigerator unit.

In more complex arrangements, the control system 100 can be programmed to switch modes according to inputs received from the clock 124 and at least one sensor, such as the door sensor 116 and/or person/movement sensor 120. For example, if the control system 100 determines that the door 5 has not been opened for a predetermined period of time and/or that the no person has approached the refrigerator unit 1 for a predetermined period of time, the system switches from the first mode to the second mode.

Stock Sensing

The display panel 108 is connected by wire 9 to the stock sensor 110, which is fixed to the rear wall 3. The stock sensor 110 is a photosensor.

Inside the refrigerator unit 1 are four shelves 11, each illustrated here carrying drinks cans 12 to its maximum capacity. At the front of each shelf, aligned on either side of the shelves and with the vertical side walls 2 are lights 13, in this case fluorescent strip lights.

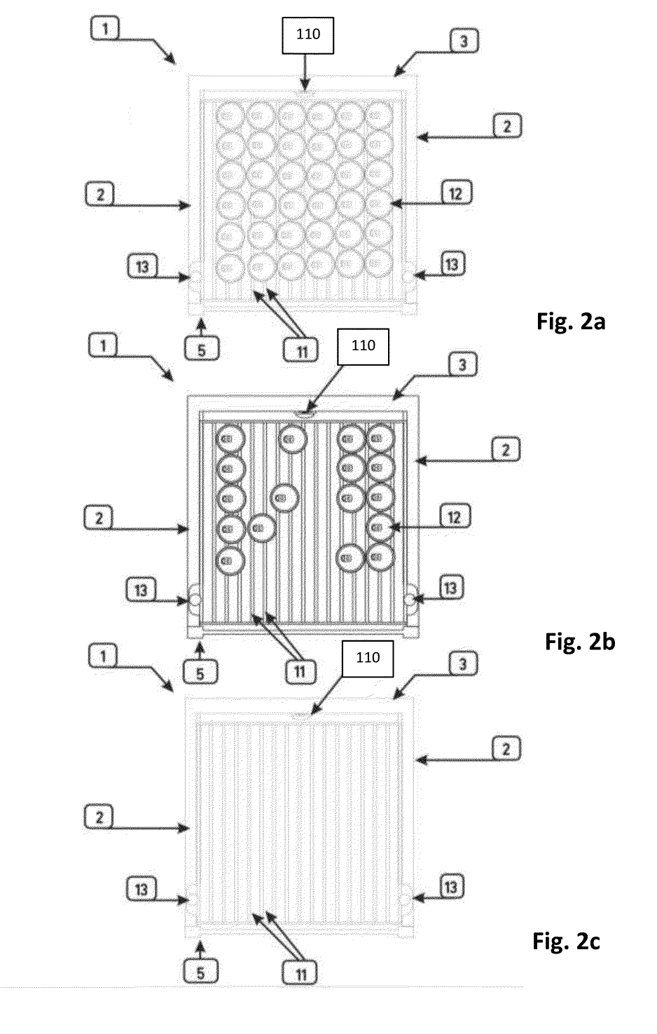

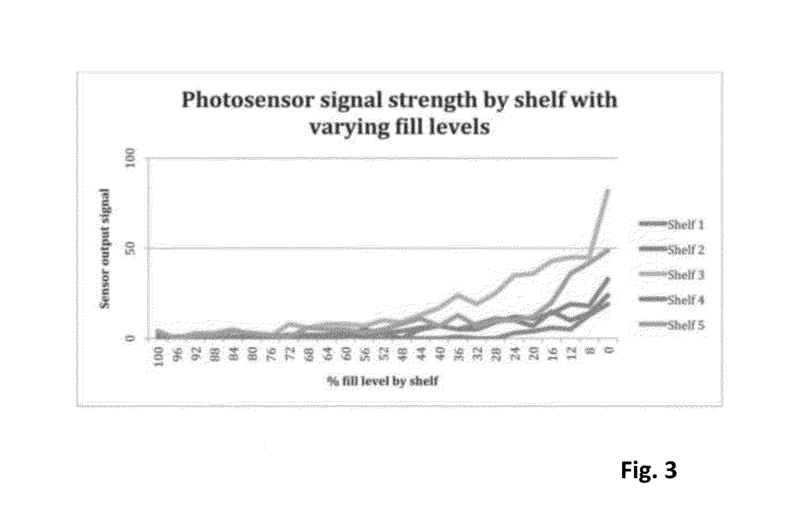

Turning to FIG. 2, the refrigerator unit 1 of FIG. 1 is illustrated as a plan view from above. In FIG. 2A, the top shelf 11 is illustrated as a wire rack comprising a number of rods that extend from front to back of the refrigerator unit 1. The shelf 11 is stocked to maximum capacity with drinks cans 12. In this configuration, illumination provided by the lights 13 will be absorbed by the cans 12 and to the light level reaching the photosensor 110 located on the rear wall 3 will be low (see FIG. 3 and Table 1).

TABLE 1

| | Photosensor signal strength | | | | |
|---|---|---|---|---|---|
| Fill level by | measured at microprocessor | | | | |
| shelf | Shelf 1 | Shelf 2 | Shelf 3 | Shelf 4 | Shelf 5 |
| 100 | 2 | 0 | 4 | 0 | 4 |
| 96 | 0 | 0 | 0 | 1 | 0 |
| 92 | 0 | 1 | 3 | 1 | 2 |
| 88 | 0 | 1 | 3 | 1 | 2 |
| 84 | 0 | 0 | 5 | 1 | 4 |
| 80 | 0 | 0 | 2 | 1 | 3 |
| 76 | 0 | 0 | 1 | 1 | 2 |
| 72 | 0 | 1 | 8 | 2 | 1 |
| 68 | 0 | 0 | 6 | 2 | 6 |
| 64 | 2 | 0 | 8 | 2 | 5 |
| 60 | 4 | 1 | 8 | 2 | 5 |
| 56 | 0 | 2 | 7 | 5 | 3 |
| 52 | 0 | 3 | 10 | 3 | 5 |
| 48 | 0 | 0 | 9 | 4 | 8 |
| 44 | 0 | 5 | 13 | 6 | 11 |
| 40 | 0 | 7 | 17 | 7 | 7 |
| 36 | 1 | 5 | 24 | 5 | 13 |
| 32 | 0 | 8 | 19 | 5 | 7 |
| 28 | 0 | 11 | 25 | 9 | 10 |
| 24 | 3 | 10 | 35 | 12 | 10 |
| 20 | 4 | 7 | 36 | 11 | 12 |
| 16 | 6 | 15 | 43 | 14 | 20 |
| 12 | 5 | 10 | 45 | 19 | 36 |
| 8 | 13 | 14 | 45 | 18 | 42 |
| 0 | 19 | 24 | 82 | 33 | 49 |

FIG. 2B illustrates the top shelf 11 when partially stocked with cans 12. In this configuration, some light will reach the photosensor 110 (see FIG. 3 and Table 1). If the light level corresponding to the stock level illustrated has been pre-set as indicating low stock, the photosensor 110 will send a signal to the microprocessor(s) 104 within the refrigerator unit 1 to indicate that stock on the shelf is low.

In FIG. 2C, the top shelf 11 is out of stock of cans 12. In this configuration and as shown in FIG. 3 and Table 1, maximum illumination from the lights 13 reaches the photosensor 110 and the internal microprocessor(s) 104 raises an alert. The alert may be a visual or aural alert via the display panel 108 on the front 4 of the refrigerator unit 1. Alternatively, the photosensor 110 sends an electronic signal to the microprocessor(s) 104 to inform a retailer that stock is low or missing, or instructs a supplier to provide more product.

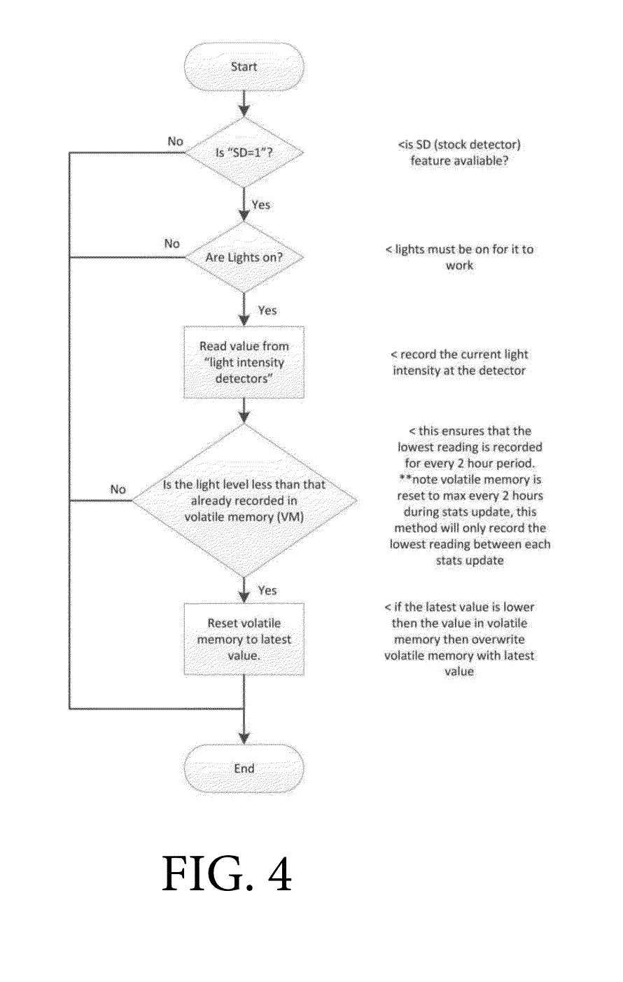

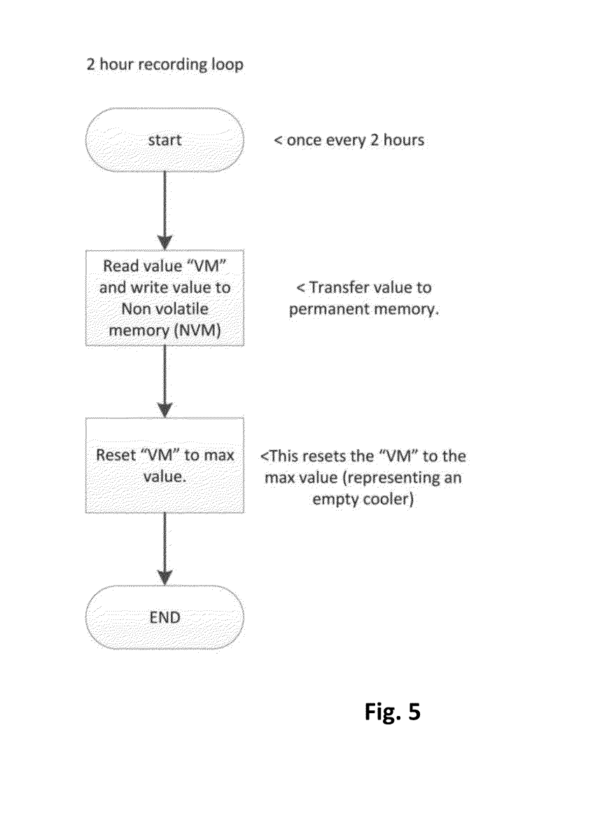

FIGS. 4 and 5 are coding flow charts setting out the chain of instructions that occur between the photosensor 110 and the microprocessor(s) 104 in the refrigerator unit 1.

First, the microprocessor(s) 104 determines whether a photosensor is present. If it is not, the request ends. If one or more photosensors are present, the microprocessor(s) checks to see whether lights 13 in the refrigerator unit 1 are on and, in this embodiment, the lights must be on for the chain of instruction to proceed.

The microprocessor(s) then takes a light reading from the photosensor 110 via a product sensor analogue to digital converter (ADC) port (not shown) and compares the reading with an optical value stored in the microprocessor(s) 104 that represents the light level when there is product in front of the photosensor 110. The stored optical value is a calibration value that equals the light reading by the photosensor 110 when there is maximum product in front of the sensor. If the light reading is greater than the stored optical value, this indicates to the microprocessor(s) that product has been removed from in front of the sensor. In the present embodiment, a single photosensor 110 reads the light level across the breadth of a single shelf. Therefore, the microprocessor(s) may include a number of stored optical values that represent calibrated values corresponding to specific levels or percentages of product remaining on the shelf.

In an alternative embodiment, the stored optical value is a calibration value that equals the light reading by the photosensor 110 when there is no product in front of the optical sensor. Thus, the microprocessor(s) 104 compares the light reading with the stored optical value and, if the light reading is substantially equal to the calibrated value, the microprocessor(s) 104 issues an alert that there is no product stocked on the shelf under interrogation. The microprocessor(s) 104 may issue a warning, such as an amber alert, if the light reading is close to the calibrate value to alert the retailer or product supplier that product stock levels are low.

The Network

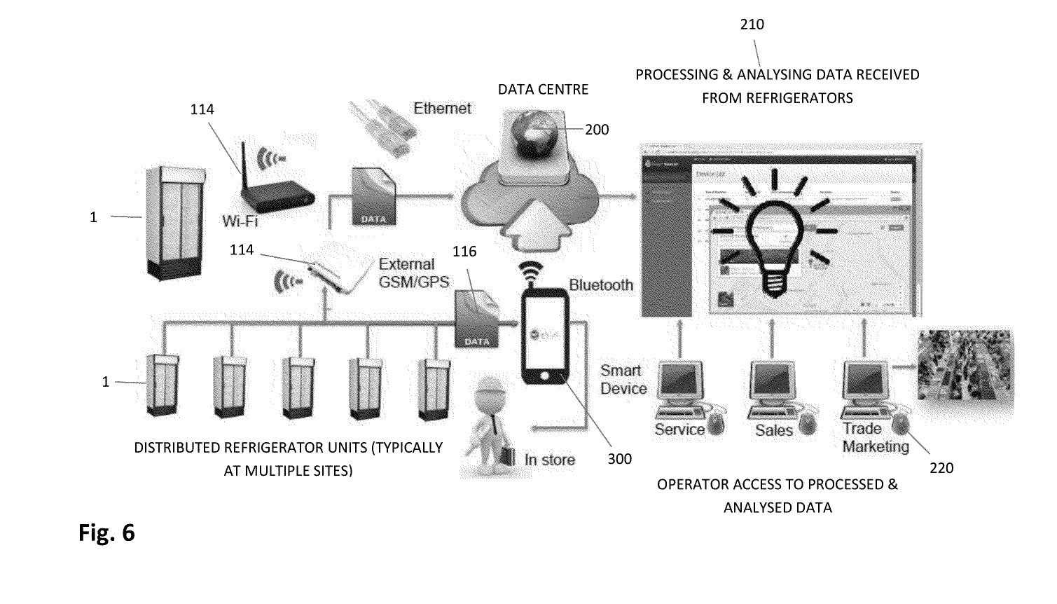

FIG. 6 shows a network of refrigerator units 1. It will be appreciated that not all of the refrigerator units 1 will be identical and that some refrigerators may stock foodstuffs other than canned drinks. In most embodiments, it is expected that the refrigerator units will be distributed over a plurality of sites, for example located at different shops, garages, etc. It is also anticipated that in some embodiments different groups of refrigerators 1 will be owned and maintained by different operator/retailers.

Each of the refrigerators 1 is connected to the internet via the first data connection module 114, and sends data to the remote data centre 200 for storage and data processing.

Data processing software 210 is provided at the remote data centre to analyse the incoming data. The processed data is then stored in a database and is made available to each operator/retailer via a user interface 220, for example via a web browser.

Since each refrigerator unit 1 includes a unique identification code, the data processing software is able to identify which data is associated with each refrigerator unit.

The operator/retailers can access several modules, which cover several broad functions: asset tracking; sales data; stock levels; maintenance (including predictive maintenance, preventative maintenance and diagnostics); and marketing (including consumer engagement and retail engagement).

The asset tracking module provides details of each refrigeration unit, including its unique identification number, location and the type of refrigeration unit 1 (model number, capacity, etc.), and enables a user to enter values for those parameters which can be set remotely.

The sales module provides sales date for each refrigerator unit, which can be separated into different product types, where products are stocked and multiple stock sensors are used.

The stock level unit displays the level of stock in each refrigerator unit, which is based on the stock level data received. Where a refrigerator unit includes more than one product type, stock data is provided for each product type. The system also provides alerts when stock levels in a refrigerator unit falls to a predetermined threshold value, or when at least one of the product types falls to a predetermined threshold value. This enables the operator/retailer to restock the refrigerator unit 1 at the earliest opportunity.

The maintenance module includes predictive maintenance, preventative maintenance and diagnostics features. It enables each operator/retailer to manage the maintenance of all of his refrigerator units 1; identify problems by monitoring error codes and data relating to the operating performance of the refrigerator unit 1, such as temperature data, door opening data, and energy usage data; and predict when parts are approaching the end of their life so that they can be replaced in a planned manner thereby preventing the refrigerator unit from breaking down.

The marketing module enables each operator/retailer to modify the information provided to the consumer mobile telephone 300_{c} from a remote location. Thus the offer provided by each refrigerator unit 1 can be changed on a regular basis as required. Footfall data received from the person/movement detection senor (and/or door sensor) can be a useful factor in determining if the refrigerator unit is located in the best position to maximise vending. It includes consumer engagement modules and retail engagement modules.

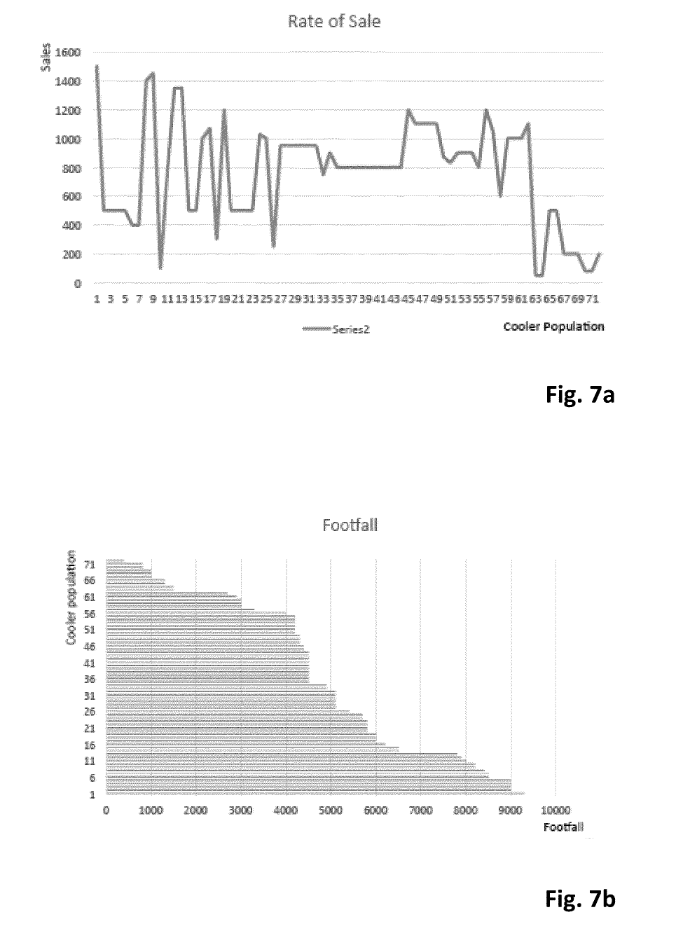

For each module, data can be provided for an individual refrigerator unit 1, or groups of refrigerator units 1. For example, an operator/retailer may want to display information for all of his refrigerator units 1 simultaneously. Examples are shown in FIGS. 7a and 7b, which are graphs showing sales versus refrigerator unit (cooler population); and footfall versus refrigerator unit, respectively.

Although the present invention has been described in connection with specific preferred embodiments, it should be understood that the invention as claimed should not be unduly limited to such specific embodiments. Furthermore, it will be apparent to the skilled person that modifications can be made to the above embodiment that fall within the scope of the invention, for example the refrigerator unit can include one or more additional sensors.

The cooling system can be a carbon dioxide cooling system.

In some embodiments the first and second data communications modules may be integrated into a single unit, for example a Wi-Fi system or Bluetooth® device.

The mobile telephone device can be replaced by a mobile computing device having a telecommunications function, such as a tablet computer.

The system can be set up for an individual operator and/or retailer. Alternatively, the system may cater for several operators and/or retailers simultaneously. In this instance, each operator and/or retailer is provided with access to data obtained from his refrigerator units only. That is, the process data is stored at the remote data centre according to operator and/or retailer accounts.

In some instances the operator and retailer can be separate companies. In other instances the operator of the refrigerator may also be the retailer of the foodstuffs.

1. A method for maintaining a retail display or vending unit, the method comprising:
obtaining and storing data from sensors located in or on the unit in a control system including data communication means, wherein the data is sent to and accessed by remote telecommunication means via the data communication means, and wherein operation of the unit is changed based on the data.

2. The method of claim 1, wherein the data is obtained from one or more type of sensor and stored in the control system.

3. The method of claim 1, wherein the data obtained by the sensors includes temperature, illumination, door opening/closing, stock level, locked/unlocked status and presence of a person.

4. The method of claim 1, wherein the method further comprises recording real time.

5. The method of claim 1, wherein the method further comprises programming a microprocessor in the control system to change settings within the control system and/or unit.

6. The method of claim 5, wherein the microprocessor is programmed to change one or more settings in the control system and/or unit based on real time.

7. The method of claim 5, wherein the microprocessor is programmed to change one or more settings in the control system and/or unit based on data received from the one or more sensors.

8. The method of claim 1, wherein the method further comprises changing settings in the control system and/or unit by or in response to a request received from the remote telecommunication means.

9. The method of claim 1, wherein the method further comprises changing an operational state of a component or module in the unit, selecting an operational mode for the unit where more than one mode is available, changing a parameter value, selecting a default setting, testing a refrigerator function, and/or updating firmware and/or software in response to the data.

10. The method of claim 9, wherein the method comprises changing the unit from a first mode to a second mode, and/or from a second mode to a first mode, at least in part, according to signals received from a clock or real-time clock or data received from at least one sensor.

11. The method of claim 1, wherein the method further comprises transmitting an identification code that is unique to the unit.

12. The method of claim 11, wherein the identification code is linked to location and/or mapping software.

13. The method of claim 1, wherein the data is sent to and accessed by either an Ethernet connection or mobile wireless internet or broadband access.

14. The method of claim 13, wherein the mobile wireless internet or broadband access is provided by one or more of: Wi-Fi, Bluetooth, General Packet Radio Service (GPRS), and Global System for Mobile Communications (GSM).

15. The method as claimed in claim 1, wherein the data communication means is an Ethernet, wireless, mobile internet or broadband connection.

16. The method of claim 1, wherein the data is sent to the remote telecommunication means either on demand or on a timed basis.

17. The method of claim 1, wherein the method further comprises requesting fault codes from the control system by the remote telecommunication means.

18. The method of claim 1, wherein the method further comprises clearing fault codes in response to instructions received from the remote telecommunication means.

19. The method of claim 1, wherein the method further includes inputting parameter values into the control system via a user interface.

20. The method of claim 19, wherein the user interface is on the unit or the remote telecommunication means.

21. The method of claim 1, wherein the remote telecommunication means is a computer or a mobile telephony device.

22. The method of claim 1, wherein the remote telecommunication means is a data center that is programmed to store data received from the control unit via the data communication means and optionally analyze the data received.
